(19) United States
(12) Patent Application Publication
(10) Pub. No.: US 2002/0142115 A1
(43) Pub. Date: Oct. 3, 2002

(54) Multi-layer film bag for packaging medical liquid

(75) Inventor: Katsuhiko Sugiura, Hiratsuka-shi (JP)

Correspondence Address: SUGHRUE MION, PLLC, 2100 Pennsylvania Avenue NW, Washington, DC, 20037-3213, US

(73) Assignee: MITSUBISHI ENGINEERING-PLASTICS CORP.

(21) Appl. No.: 09/984,859

(22) Filed: Oct. 31, 2001

(30) Foreign Application Priority Data
Nov. 1, 2000 (JP) 2000/334991

(51) Int. Cl. B32B 1/02

(52) U.S. Cl. 428/35.2

(57) ABSTRACT

A multi-layer film bag for packaging medical liquid, wherein the multi-layered film comprises at least five layers in which a polyester layer is located on the outermost, and an adhesive layer, a polyamide layer, an adhesive layer and an polyolefin layer are stacked in this order towards the innermost was disclosed. In such multi-layer film bag for packaging medical liquid, the polyester layer comprises polybutylene terephthalate which contains terephthalic acid as a major dicarboxylic acid component and butylene glycol as a major diol component; the polybutylene terephthalate has an intrinsic viscosity of 0.6 to 2.0 and the content of carboxylic terminal of 3 to 60 μeq/g. The polyamide layer comprises polyamide 6, polyamide 6-66 or a mixture thereof, and has a relative viscosity of 2.1 to 6.0, a ratio of content of low-molecular-weight polymers of 0.7 wt % or below, and an ash content of 500 ppm or below.

### TECHNICAL FIELD

The present invention relates to a multi-layer film bag for packaging medical liquid, and more specifically to a multi-layer film bag suitable for packaging medical liquids such as infusion liquid, artificial dialytic solution, liquid medicines and blood.

### BACKGROUND ART

Pouch made of synthetic polymer film is popular as conventional bag for packaging medical liquid. Such pouch is advantageous in that having flexibility and allowing easy drain of the content, and has been used as a bag for packaging medical liquid, such as an infusion liquid. Films for composing such pouch necessarily have excellent flexibility, transparency, heat resistance, hygiene, mechanical strength, gas barrier property and processability from a medical viewpoint. Moreover the films necessarily have features such as preventing vaporization and oxygen-induced denaturalization of the content, causing no volumetric expansion within the container, and being not bulky and readily disposable after use. Thus there has been a demand for the materials having all such properties in well-balanced manner.

Flexibility of the materials used for the pouch is a necessary feature for ensuring stable and complete dripping even under the atmospheric pressure during administering a drip infusion, for keeping the bag unbroken even when it is accidentally fallen on the floor or the like under cold temperatures, and for allowing compact disposal of the container while being reduced in the volume after use.

Transparency of the materials for the pouch is a necessary feature for allowing visual confirmation of the foreign matter contamination or net volume of the content during a process for packing the content such as infusion liquid or liquid medicines, or after such packing.

Heat resistance of the materials for the pouch is desired so as to avoid deformation, breakage, liquid leakage, lowered transparency and lowered flexibility of the pouch during sterilization under high-pressure steam in order to obtain germ-free infusion liquid or the like.

Other requirement for the products filled with a medical liquid relates to mechanical strength durable under severe environment, which is sufficient to prevent flaw, pinhole, breakage or the like due to friction, wear, scratch, falling and vibration during the production, transportation or usage.

In Japan, the pouch for medical use should attain hygienic level certifiable by the test method for plastic-made medical packaging materials in the Japanese Pharmacopoeia Thirteenth Edition.

Vinyl chloride-base polymer film has been used as a material for composing such pouch since it has the foregoing various properties in a relatively well-balanced manner. The vinyl chloride-base polymer may, however, cause elution of plasticizer or stabilizer blended therein into the content It is also pointed out that there is a risk that incineration of such polymer after use may generate chlorine gas or dioxin. So that it is no more preferable in terms of hygiene, safety and reduction in environmental impact, and there are growing demands for the substitute.

Another proposal relates to a multi-layer bag for packaging infusion liquid typically comprising four layers of polyolefin layer/adhesive layer/polyamide layer/low-moisture-permeability resin layer, where “/” represents boundary of the adjacent layers, the same will apply hereinafter (Japanese Laid-Open Patent Publication No. 60-55958). While being excellent in flexibility and processability, the four-layered film was found to be still unsatisfactory in terms of anti-pinhole property, heat resistance, heat sealing property, transparency, hygiene and safety.

The low-moisture-permeability resin composing the outermost layer of the four-layered film is made of polyethylene, which raises another problem that letters written thereon with an oil-base, felt-tip pen or a label placed thereon having a printed patient's name may readily be erased or peeled off when cotton immersed with disinfectant alcohol in the neighborhood accidentally comes into contact therewith. This results in difficulty in discriminating a bag of desired liquid from the others when a plurality of bags of medical liquids are displayed, which may induce errors in medical treatments, unwilling disposal of indistinguishable liquid medicines, and thus result in increase in medical cost.

Another known example of the bag is such that being obtained by heat-sealing a multi-layered film comprising at least two layers in which the outermost layer is a polyester layer, and the innermost layer is a polyolefin layer which comprising a copolymer of ethylene and a C₃₋₁₈ α-olefin, which is intended for packaging refreshing beverage. The description said that such bag for packaging refreshing beverage is disposable in a compact volume, and is excellent in barrier property against odor, less odorous, anti-pinhole property, and breakage resistance. As one specific example thereof, a multi-layered film having a five-layered constitution of polyester/adhesive/polyamide/adhesive/polyolefin is exemplified (Japanese Laid-Open Patent Publication No. 2000-72150). The polyamide used herein is, however, a commercial polyamide for producing film, which is not properly optimized in terms of the content of low molecular-weight polymer and ash content. So that a problem has arisen that the multi-layered film using such polyamide is inappropriate for use as a multi-layer film bag for packaging medical liquid, since the evaporation residue test thereof showed unsatisfactory results. Thus the film is absolutely unintended for medical use. As for the polymer in the polyester layer, the patent publication describes that polyethylene terephthalate, besides polybutylene terephthalate, is also available with a lower resistance against bag fall. There is, however, no description on the flexibility and haze, which are essential properties in medical use, and there is thus no description on that these properties are inferior to those of polybutylene terephthalate.

Considering the above situation, the present inventors reached the present invention after extensive investigation aiming at providing a bag for packaging liquid especially suitable for medical use, which is excellent in heat sealing property, barrier property, low odor, anti-pinhole property, heat resistance, hygiene, mechanical strength, transparency, flexibility and processability; on which letters written with a felt-tip pen are not readily erasable; and convenient for compact disposal after use.

### SUMMARY OF THE INVENTION

To solve the foregoing problems, the present invention is to provide a multi-layer film bag for packaging medical liquid, wherein the multi-layered film comprises at least five layers in which a polyester layer is located on the outermost, and an adhesive layer, a polyamide layer, an adhesive layer and an polyolefin layer are stacked in this order towards the innermost. The polyester layer comprises polybutylene terephthalate which contains terephthalic acid as a major dicarboxylic acid component and butylene glycol as a major diol component; the polybutylene terephthalate has an intrinsic viscosity of 0.6 to 2.0 and the content of carboxylic end group of 3 to 60 μeq/g. The polyamide layer comprises polyamide 6, polyamide 6-66 or a mixture thereof, and has a relative viscosity of 2.1 to 6.0, a ratio of content of low-molecular-weight polymers of 0.7 wt % or below, and an ash content of 500 ppm or below.

In a preferred embodiment of the present invention, the total thickness of the multi-layered film is 0.08 to 0.6 mm, the thickness of the polyolefin layer and the adhesive layers are 0.003 to 0.2 mm, the thickness of the polyester layer is 0.005 to 0.2 mm, and the thickness of the polyamide layer is 0.003 to 0.06 mm.

In a preferred embodiment of the present invention, the polybutylene terephthalate is a polymer or a copolymer in which the dicarboxylic acid component thereof comprises terephthalic acid, and the diol components thereof comprises 70 to 100 wt % of butylene glycol and 30 to 0 wt % of polybutylene glycol having a weight average molecular weight of 400 to 3000; the polybutylene terephthalate has an intrinsic viscosity of 0.9 to 1.5; and the polybutylene terephthalate has a content of carboxylic end group of 3 to 40 μeq/g.

In a preferred embodiment of the present invention, the polyamide 6, polyamide 6-66 or mixture thereof has a ratio of content of low-molecular-weight polymer of 0.5 wt % or below; and the polyamide 6 or polyamide 6-66 has an ash content of 300 ppm or below.

In a preferred embodiment of the present invention, the polyolefin layer comprises any one component selected from the group consisting of polyethylene, polypropylene, and mixture of ethylene-propylene copolymer and polyethylene; the polyolefin layer comprises a polymer which has an MFR of 0.1 to 30 g/min and when the polyolefin layer is mainly composed of ethylene; or the polyolefin layer comprises a polymer which has an MFR of 0.1 to 100 g/min when the polyolefin layer is mainly composed of propylene or styrene.

In a preferred embodiment of the present invention, the adhesive layer mainly comprises a modified polyolefin; the modified polyolefin is a polymer mainly composed of ethylene, and has an MFR of 0.1 to 30 g/min; or the modified polyolefin is a polymer mainly composed of propylene or styrene and has an MFR of 0.1 to 100 g/min.

In a preferred embodiment of the present invention, the multi-layered film is produced by the multi-layer co-exclusion process; the multi-layered film is produced by the water-cooled inflation molding process; or the multi-layered film is produced in a cylindrical form by the water-cooled inflation molding process and then heat-sealed at least partially.

As one preferred embodiment of the present invention, provided is a multi-layer film bag for packaging at least one medical liquid selected from infusion liquid, artificial kidney dialysis solution, peritoneal dialysis solution (CAPD), blood, humor and liquid medicines.

### DETAILED DESCRIPTION OF THE INVENTION

The multi-layer film bag for packaging at least one medical liquid according to the present invention comprises at least five layers in which a polyolefin layer is located on the innermost, and an adhesive layer, a polyamide layer, an adhesive layer and a polyester layer are stacked in this order towards the outermost. “At least five layers” prescribed herein means that the five-layered constitution is the minimum constitution, and that any constitutions with additional layers to have six layers or more layers (e.g., six-layered and seven-layered constitutions) are also inclusive.

The polyester composing the polyester layer is a polybutylene terephthalate having an intrinsic viscosity of 0.6 to 2.0 and the content of carboxylic end group of 3 to 60 μeq/g, and containing terephthalic acid as a major dicarboxylic acid component and butylene glycol as a major diol component.

The dicarboxylic acid may be anything so far as it contains terephthalic acid as its main component, and it may contain dicarboxylic acid component selected from aromatic dicarboxylic acids such as isophthalic acid, 2,6-naphthalene dicarboxylic acid, 1,5naphthalene dicarboxylic acid, bis(4,4′-carboxyphenyl)methane, anthracene dicarboxylic acid and 4,4′-diphenylether dicarboxylic acid; alicyclic dicarboxylic acids such as 1,4-cyclohexane dicarboxylic acid and 4,4′-dicyclohexyl dicarboxylic acid; aliphatic dicarboxylic acids such as adipic acid, sebacic acid, azelaic acid and dimer acid; and ester derivatives thereof. As for the case that terephthalic acid and other dicaroboxylic acid are used in combination, a particularly preferable combination is such that containing terephthalic acid in an amount of 40 to 100 wt % and isophthalic acid in an amount of 0 to 60 wt %.

The diol component may be anything so far as it contains butylene glycol (tetra methylene glycol) as its main component, it may contain glycol component selected from ethylene glycol, propylene glycol, trimethylene glycol and polybutylene glycol. When butylene glycol and other diol component are used in combination, a preferable combination is such that containing butylene glycol and polybutylene glycol having a weight average molecular weight of 400 to 3000, where butylene glycol is preferably contained in an amount of 70 to 100 wt %, and polybutylene glycol in an amount of 30 to 0 wt %.

Various polyesters can be obtained by properly selecting both components and subjecting them to condensation polymerization in an arbitrary combination, where polybutylene terephthalate (Homo-PBT) obtained by condensation polymerization of terephthalic acid and butylene glycol, or copolymer PBT (Co-PBT) obtained by condensation polymerization of terephthalic acid and a diol component which comprises a mixture of butylene glycol and polybutylene glycol according to the ratio described in the above is particularly preferable in terms of odor barrier property, transparency, flexibility, oxygen barrier property, availability and price.

The intrinsic viscosity of the polyester must be within a range from 0.6 to 2.0. If the intrinsic viscosity is smaller than 0.6, a fluidization of the polymer is uneven due to much small melt viscosity during the fabrication of the multi-layered film, and thereby undesirable striations or melt fractures appears on the film surface, which make the appearance of the film and merchandise value poor. Or only the melt polyester layer falls from another layers by its own weight during fusion, and thereby the layer undesirably is discontinuous or uneven in thickness, which extremely ruins the film property. On the other hand, if the intrinsic viscosity exceeds 2.0, the fluidity of the polymer undesirably unbalances with the fluidity of other polymers due to much high melt viscosity or the motor torque undesirably increases during the film production by the extrusion molding process. The intrinsic viscosity preferably resides within a range from 0.9 to 1.5, and more preferably from 1.0 to 1.4. It should now be noted that the intrinsic viscosity of the polyester is defined as a measured value obtained at 30° C. for a solution thereof prepared by dissolving 0.1 g of such polymer in 100 ml of a 1:1 (w/w) mixed solvent of tetrachloroethane and phenol.

Methods generally known for obtaining a polyester having an intrinsic viscosity higher than 1.0 include such that carrying out condensation reaction under fusion at high temperature and low pressure (melt polymerization), and such that once taking the polymer in a low-molecular-weight status out from a polymerization tank and then allowing the polymerization to proceed at a temperature not higher than the melting point of such polymer in vacuo or under a nitrogen atmosphere (solid phase polymerization). Since the polyester with a less content of oligomer components or impurity components is preferred for the application according to the present invention, those produced by the solid phase polymerization process are more preferable. Those produced by the melt polymerization process contain a slightly larger amount of oligomers or reaction by-products other than PBT as compared with those obtained by the solid phase polymerization process. While they are successfully used in their intact state, volatile components such as the oligomers can further be reduced by the vacuum drying process in a drying stage before the film processing.

It is necessary that the content of carboxylic end groups of the polyester is within a range from 3 to 60 μeq/g. If the content of carboxylic end groups exceeds 60 μeq/g, the thermal stability of the polymer undesirably lowers during the film processing the color of a film made of the polymer changes yellow and the sterilization resistance of the film lowers. The content of carboxylic end groups is preferably 3 to 40 μeq/g, and more preferably 3 to 25 μeq/g. The content of carboxylic end groups in the polyester is measured by neutralization titration. The crushed sample is dried, 0.1 g of which is precisely weighed, added with 3 ml of benzyl alcohol, and then dissolved under stirring and nitrogen bubbling on an oil bath at 195° C. When the sample polymer dissolved, the resultant solution is added with 5 ml of chloroform and an indicator, and then titrated with a 0.1 N NaOH solution in benzyl alcohol under nitrogen bubbling. Using the titration volume, the content of the carboxylic end groups is calculated from the equation below:

$$( \begin{matrix}content of carboxylic \\ end groups\end{matrix} ) = \frac{( titration v olume ) \times 0.1 \times F}{( amount of sample )}$$

where F is titer of a 0.1 N NaOH/benzyl alcohol solution, and the content of carboxylic end grout is expressed in μeq/g, the titration volume in μl and amount of sample in g.

Polyamide composing the polyamide layer is polyamide 6, polyamide 6-66 or mixtures thereof. Polyamide 6 and polyamide 6-66 can be obtained by carrying out condensation polymerization of 100 to 3 weight parts of ε-caprolactam and 0 to 90 weight parts or an equimolar salt of adipic acid and hexamethylenediamine, which totals 100 weight parts. Using only ε-caprolactam will yield polyamide 6. The ratio of repetitive units derived from ε-caprolactam in polyamide 6 or polyamide 6-66 is preferably 100 to 10 wt %. Too small content of the repetitive units derived from ε-caprolactam will undesirably degrade the formability and mechanical strength of the polyamide layer. The content of repetitive units derived from E-caprolactam is more preferably 100 to 30 wt %, and most preferably 100 to 50 wt %.

Such polyamide 6 or polyamide 6-66 has a relative viscosity within a range from 2.1 to 6.0 when measured for an 1% solution thereof in a 98% sulfuric acid at 25° C. in compliance with JIS K6810. If the relative viscosity is less than 2.1, the extrusion pressure of the polyamide layer doesn't elevate enough due to low viscosity of the molten polymer, and thereby the flow of the layer undesirably lacks of uniformity, which results in scaly texture or partial omission of the layer, and the bubble stability undesirably degrade during inflation molding process. On the contrary, if the relative viscosity exceeds 6.0, the motor torque is undesirably too high to extrude the polyamide layer, or the extrusion pressure for forming a film is undesirably so high due to much high viscosity of the molten polymer that the flow of the adjacent layer is disturbed. This results in appearing strains on the adjacent layer, causing partial omission in the adjacent adhesive layer to thereby lower the bag breakage strength, or causing breakage of the innermost polyolefin layer during filling of the content.

The relative viscosity of the polyamide 6 or polyamide 6-66 is preferably 2.5 to 4.5, and more preferably 3.0 to 4.0, from the viewpoint of improving the moldability, which can be attained by approximating the melt viscosity to that of the adjacent adhesive layer.

The end group of polyamide 6 or polyamide 6-66 can be terminated by monocarboxylic acid or monoamine. Possible examples include polyamide 6 terminated by C₂₋₂₂ monocarboxylic acid or monoamine, and polyamide 6-66 terminated by a C₂₋₂₂ monocarboxylic acid or monoamine.

It is necessary that polyamide 6 or polyamide 6-66 composing the polyamide layer has the content of low-molecular-weight polymer(oligomer) of 0.7 wt % or less. In the present invention, the content of low-molecular-weight polymer is defined as a measured value obtained in compliance with JIS 6810. Polymerization reaction of polyamide is an equilibrium reaction, and polymer discharged from a polymerization tank in a strand form and cut in a pellet form after cooled generally contains approx. 10 wt % of the low-molecular-weight polymer (oligomer). Such low-molecular-weight polymer contained within the pellets can be removed by the aqueous extraction process (a method for extracting and removing the low-molecular-weight polymer by repetitive washing of the pellets with hot water). The more the number of times of the aqueous extraction increases, the more the content of the low-molecular-weight polymer within the pellets decreases. Conventional polyamide 6 or polyamide 6-66 film generally used for packaging foods or medical liquid has a content of low-molecular-weight polymer reduced to at most as low as approx. 1.5 wt % or below. On the other hand, the multi-layered film for producing bag for packaging medical liquid of the present invention has a content of low-molecular-weight polymer suppressed further as low as 0.7 wt % or below by increasing the number of times of the aqueous extraction. The content of low-molecular-weight polymer exceeding 0.7 wt % will cause elution of such low-molecular-weight polymer into the content. The content of the low-molecular-weight polymer is preferably 0.6 wt % or below, and more preferably 0.5 wt % or below.

It is necessary that polyamide 6 or polyamide 6-66 composing the polyamide layer has an ash content of 500 ppm or below. It should now be noted that the ash content prescribed in the present invention is defined as a measured value obtained by ashing 50 g of pellet in an electric furnace at 600° C. and weighting the resultant ash. The ash content exceeding 500 ppm will lower the anti-pinhole property and gas barrier property of the bag. The ash content is preferably 300 ppm or below, and more preferably 100 ppm or below. While polyamide 6 or polyamide 6-66 for use in general films is added with 1,000 ppm or around of silica, talc or kaolin in order to improve the processability and low friction coefficient, those used for composing the bag for packaging medical liquid according to the present invention are embedded as an intermediate layer of the multi-layered film, so that there is no need to add function such as low friction coefficient, and it is necessary that such additives are added in a minimum amount as a stabilizer for preventing biting into screws.

In the present invention, the foregoing conditions on the ratio of content of such low-molecular-weight polymer and ash content must be satisfied, otherwise the multi-layer film bag will not pass the test for plastic-made medical packaging materials and elution test specified in the Japanese Pharmacopoeia Thirteenth Edition.

It is also allowable for the bag for packaging medical liquid of the present invention that the polyamide layer is added with one or more layers comprising partially saponified ethylene vinylalcohol vinyl acetate copolymer (generally referred to as EVOH) in order to enhance the oxygen barrier property depending on the liquid contained therein.

Polymer which can compose the polyolefin layer is polyolefin having ethylene, propylene or styrene as a major component. Specific examples thereof include unmodified polyolefins such as polyethylene, polypropylene, ethylene-propylene copolymer, ethylene-1-butene copolymer, ethylene-vinyl acetate copolymer, ethylene-acrylic acid copolymer, ethylene-ethyl acrylate copolymer, ethylene-sodium acrylate copolymer, styrene-isoprene copolymer and styrene-isobutylene copolymer.

As for the polyolefin containing ethylene as a major component is preferably such that having an MFR (melt flow rate) of 0.1 to 30 g/min. The MFR larger than the above range will undesirably degrade the heat resistance and strength of the film, and will destabilize the process step for fabricating the film. The MFR smaller than the above range undesirably raise the pressure of the molten polymer during the film fabrication to thereby degrade the extrusion property. The MFR is more preferable when the value thereof resides within a range from 0.3 to 20 g/min, and more preferably from 0.3 to 15 g/min. Note that the MFR prescribed in the present invention is defined as a measured value obtained in compliance with JIS K7210 (at 190° C. under 2.16 kg load).

As for the polyolefin containing propylene or styrene as a major component is preferably such that having an MFR or 0.1 to 100 g/min. The MFR larger than the above range will undesirably degrade the film strength and will destabilize the process step for fabricating the film. The MFR smaller than the above range undesirably raise the pressure of the molten polymer during the film fabrication to thereby degrade the extrusion property. The MFR is more preferable when the value thereof resides within a range from 0.3 to 80 g/min, and more preferably from 0.3 to 50 g/min.

In the bag for packaging medical liquid according to the present invention, adhesive layer are interposed between layers of different polymers. Modified polyolefin is a preferable adhesive for composing the adhesive layers. The modified polyolefin refers to an polyolefin modified with α,β-unsaturated carboxylic acid. More specifically, examples thereof include copolymer (a) of olefins, which contains ethylene, propylene or styrene as the main component, and α,β-unsaturated carboxylic acid or derivatives thereof; and graft polymer (b) obtained by grafting α,β-unsaturated carboxylic acid or derivative thereof to polymer of olefins, which contains ethylene, propylene or styrene as the main component.

Examples of such α,β-unsaturated carboxylic acid or derivative thereof of the copolymer (a) include acrylic acid, methacrylic acid, methylmethacrylic acid, sodium acrylate, zinc acrylate, vinyl acetate and glycidyl methacrylate. Specific examples of the copolymer (a) include ethylenevinyl acetate copolymer, ethylene-acrylic acid copolymer, ethylene-ethyl acrylate copolymer and ethylene-sodium acrylate copolymer. The ratio of content of the α,β-unsaturated carboxylic acid or derivative thereof in the copolymer (a) is preferably 40 mol % or below.

Examples of polyolefins which can used as a base material for the graft polymer (b) include polyethylene, polypropylene, ethylene-propylene copolymer, ethylene-1-butene copolymer, ethylene-vinyl acetate copolymer, ethylene-acrylate copolymer, ethylene-ethyl acrylate copolymer, ethylene-sodium acrylate copolymer, styrene-isoprene copolymer and styrene-isobutylene copolymer.

Examples of the α,β-unsaturated carboxylic acid or derivatives thereof to be grafted to the polyolefins include acrylic acid, methacrylic acid, ethacrylic acid, maleic acid, fumaric acid, acid anhydride thereof, and esters formed between such acids and tetrahydrofurfuryl alcohol or the like. Among such components to be grafted, particularly preferable is maleic anhydride. The amount of grafting is selected within a range from 0.05 to 1.5 wt % of the polyolefins.

Grafting α,β-unsaturated carboxylic acid or derivative thereof to the polyolefins is attained by mixing both components according to general procedures, and then fusing at a polymer temperature of 150 to 300° C. Addition of an organic peroxide such asα,α′-bis-t-butylperoxy-p-diisopropylbenzene in an amount of 0.001 to 0.05 wt % relative to the polyolefin can improve efficiency of the grafting.

The modified polyolefins, especially those containing ethylene as a major component, preferably have an MFR of 0.1 to 30 g/min. The MFR larger than the above range will undesirably lower the heat resistance and film strength, and will destabilize the film formation. On the other hand, the MFR smaller than the above range will undesirably raise the polymer pressure to thereby degrade the extrusion property. More preferable range of the MFR is 0.3 to 20 g/min, and still more preferable range resides in a range from 0.3 to 15 g/min.

Among such modified polyolefins, those having propylene or styrene as a major component preferably have the MFR within a range from 0.1 to 100 g/min. The MFR larger than the above range will undesirably lower the film strength, and will destabilize the film formation. On the other hand, the MFR smaller than the above range will undesirably raise the polymer pressure to thereby degrade the extrusion property. More preferable range of the MFR is 0.3 to 80 g/min, and still more preferable range resides in a range from 0.3 to 50 g/min.

The modified polyolefins can be mixed with unmodified polyolefins in an amount within a range from 0 to 97 wt %. The ratio of mixing of such unmodified polyolefin is preferably 0 to 95 wt %, and more preferably 0 to 90 wt %. The unmodified polyolefin exceeding 97 wt % will undesirably degrade the adhesive property of the adhesive layers.

The individual layers composing the bag for packaging medical liquid according to the present invention can further be added with a variety of known additives such as pigment, dye, heat stabilizer and antistatic agent without departing from the scope of the invention and without ruining the object thereof.

General multi-layer co-extrusion process is typified as a most preferable method for forming the film used for the bag for packaging medical liquid according to the present invention. Water-cooled, multi-layer co-extrusion inflation process is considered as a more preferable process from the viewpoint of improving transparency of the polyester, whereby molten polymer in a multi-layered flow is continuously extruded from a circular die, the resultant extruded material is kept in a cylindrical form by blowing air inside thereof, and then brought into contact with water to effect cooling. This process is advantageous not only in that the polyester can be improved in the transparency, but also in that the interior face to be bought into contact with the content does not contact with the air nor cooling water before the content is packed, so that there is no fear of contamination with foreign matters such as insects and hair. Thus the method is particularly preferable for fabricating the bag for packaging medical liquid.

Such film produced by the water-cooled, multi-layered co-extrusion inflation molding can further be stretched if the situation demands.

Other possible film forming methods include such that forming the individual layers separately into films, stretching the films as required, and stacking the individual films by adhesion or heat press to thereby produce a multi layered film, or such that performing air-cooled, multi-layer co-extrusion inflation process.

Exemplary constitutions of the multi-layered film used for producing the bag for packaging medical liquid according to the present invention are as those listed below. In the notation of the constitutions of the multi-layered film listed below, the individual layers are shown as being stacked in the order from the outermost layer to the innermost layer, PO represents polyolefin, PA represents polyamide and PEST represents polyester. PO(1) and PO(2) now represent different polyolefins satisfying a relation of PO(1)>PO(2) in terms of bending elastic modulus; PA(1) and PA(2) represent different polyamides; EVOH represents a partially saponified product of ethylene vinylalcohol vinyl acetate copolymer; and PEST(1) and PEST(2) are in a relation of PEST(1)≦PEST(2) in terms of melting point measured by DSC.

PEST/adhesive layer/PA/adhesive layer/PO

PEST/adhesive layer/PA(2)/PA(1)/adhesive layer/PO

PEST(2)/adhesive layer/PEST(1)/adhesive layer/PA/adhesive layer/PO

PEST/PO(2)/adhesive layer/PA/adhesive layer/PO(2)/PO(1)

PEST/adhesive layer/PA/adhesive layer/PA/adhesive layer/PO

PEST/adhesive layer/PA(2)/adhesive layer/PA(1)/adhesive layer/PO

PEST(2)/adhesive layer/PA/adhesive layer/P(2)/PO(1)

PEST/PO(2)/adhesive layer/PA(2)/adhesive layer/PA(1)/adhesive layer/PO(2)/PO(1)

PEST/adhesive layer/PA/EVOH/adhesive layer/PO

Note that the constitution of the multi-layered film is by no means limited to those shown in the above. The total thickness of the multi-layered film is preferably within a range from 0.08 to 0.6 mm. The thickness less than 0.08 mm will ruin massive touch, and exceeding 0.6 mm tends to lack flexibility, both being undesirable. A more preferably range is 0.1 to 0.5 mm. The thickness of the polyester layer placed on the outermost of the multi-layered film is preferably within a range from 0.005 to 0.2 mm. The thickness less than 0.005 mm will degrade odor barrier property and breakage resistance against scratch, and exceeding 0.2 mm will harden the bag and make hazy the transparency, both being undesirable.

The thickness of the polyamide layer is preferably within a range from 0.003 to 0.06 mm. The thickness less than 0.003 mm will degrade the mechanical strength and gas barrier property, and exceeding 0.06 mm will become rigid and make hazy, both being undesirable. A more desirable range is from 0.005 to 0.05 mm, and a still more preferable range is from 0.01 to 0.04 mm. The thickness of the polyolefin placed at the innermost of the multi-layered film is preferably within a range from 0.003 to 0.1 mm. The thickness less than 0.003 mm will degrade the heat resistance, and exceeding 0.1 mm will become rigid and make hazy, both being undesirable. The thickness of the adhesive layer is preferably within a range from 0.003 to 0.2 mm. The thickness less than 0.003 mm will weaken the adhesive property, and exceeding 0.2 mm will ruin the flexibility and transparency, both being undesirable. A more preferable range of the adhesive layer is within a range from 0.01 to 0.1 mm.

Any known conventional bag making processes are applicable to the production of the bag for packaging medial liquid according to the present invention from such multi-layered film. Structure of such bag for packaging liquid may be of multi-chambered or single-chambered, and may be such that being provided with spout or the like. The multi-layer film bag for packaging medical liquid according to the present invention is successfully prevented from being curled at the edge.

Since the multi-layer film bag for packaging medical liquid according to the present invention has the polyester layer on the outermost, various odors ascribable to odorous liquid contained therein, such as those from acetic acid or derivatives thereof, amine, sulfur-containing compounds, or mixtures thereof, are prevented from leaking outside the liquid bag, so that pollution of handling environment or storage environment is avoidable even when the bags filled with such odorous liquid are handled or stored.

Unlike the conventional constitution having a polyolefin layer on the outermost, the bag having a polyester layer on the outermost is advantageous in that improving the ink affinity of the surface even if such surface is not subjected to corona discharge treatment. This simplifies the fabrication process of the multi-layered film, allows direct printing of product name or description of such product on the surface of the bag, improves wear-resistant property of the printed surface and to thereby prevent erasure due to friction or wear during the transportation, and improves mechanical strength of the bag to thereby upgrade the anti-breakage effect.

The bag for medical purpose is often subjected to pretreatment, such as heating sterilization at high temperatures for example, under conditions severer than those for bags for other purposes (beverage, foods, etc.). More specifically, heating sterilization for medical purpose is usually effected at 120° C. or above, where such condition is severer than that for beverage or the like generally sterilized at 100° C. or around. The conventional bags having the polyolefin layer on the outermost were sometimes found to fuse with each other when they were subjected to heating sterilization while being stacked. On the contrary, the bags for packaging medical liquid according to the present invention have improved heat resistance, so that fusion of the bags is completely avoidable even if such bags are subjected to the heating sterilization while being stacked, which allows heating sterilization in a large batch.

In particular in the practical use of the bag for packaging medical liquid according to the present invention at the work places such as in hospitals, accidental film breakage due to scratched or rubbed by something will hardly occur. The bag for packaging medical liquid has often written thereon description of a patient's name or drug name with an oil-base, felt-tip pen, where such description will not easily be erased even when cotton immersed with disinfectant alcohol comes into contact therewith, or the bag once dropped on the floor is wiped with cotton immersed with disinfectant alcohol. Also a label having printed thereon a liquid name and placed on the surface of the bag will not easily be peeled off, which is beneficial in preventing troubles in the medical field.

The multi-layer film bag for packaging medical liquid according to the present invention is useful for packaging various medical liquids for clinical use, and also for injection, discharge and storage of infusion liquid, liquid for artificial kidney dialysis, liquid for peritoneal dialysis, blood, humor and liquid medicines.

The present invention will further be detailed referring to the preferred Examples. It should now be noted that the present invention is by no means limited to the Examples below unless otherwise departing from the spirit thereof.

Materials used for Examples and Comparative Examples described in the next are as follows:

(1) PEST(A): a Homo-PBT obtained by solid phase polymerization of terephthalic acid with butylene glycol, having an intrinsic viscosity of 1.2 and a content of carboxylic terminal group of 18 μeq/g;

(2) PEST(B): a Co-PBT obtained by solid phase polymerization of terephthalic acid with a mixed diol component which comprises 90 wt % of butylene glycol and 10 wt % of polyethylene glycol having a weight average molecular weight of 1,000, having an intrinsic viscosity of 1.15 and a content of carboxylic terminal group of 17 μeq/g;

(3) PEST(C): a Co-PBT obtained by solid phase polymerization of terephthalic acid with a mixed diol component, which comprises 80 wt % of butylene glycol and 20 wt % of polyethylene glycol having a weight average molecular weigh of 1,000, having an intrinsic viscosity of 1.30 and a content of carboxylic terminal group of 20 μeq/g;

(4) PEST(D) (used in Comparative Example): a Homo-PET obtained by melt polymerization of terephthalic acid with ethylene glycol, having intrinsic viscosity of 0.65 and a content of carboxylic terminal group of 50 μeq/g;

(5) PA(A): a polyamide 6 having a relative viscosity of 3.7, a ratio of content of low-molecular-weight polymer of 0.35 wt % which was lowered by repetitive aqueous extraction of polyamide same as PA(B) described next, and an ash content of 5 ppm;

(6) PA(B): a polyamide 6 having a relative viscosity of 3.7, a ratio of content of low-molecular-weight polymer of 1.5 wt %, and an ash content of 5 ppm;

(7) PA(C): a polyamide 6 obtained similarly to PA (A) except being added silica (product of Fuji Silysia Chemical Ltd., grade name: SYLYSIA 740) in an amount of 1,000 ppm during the polymerization, having a relative viscosity of 3.7 and a ratio of content of low-molecular-weight polymer of 0.35 wt %;

(8) PA(D): a polyamide 6-66 having a relative viscosity of 4.5, a ratio of content of low-molecular-weight polymer of 0.47 wt % which was lowered by repetitive aqueous extraction, and an ash content of 10 ppm;

(9) PA(E): a polyamide 6, having a relative viscosity of 2.0, a ratio of content of low-molecular-weight polymer of 0.40 wt % which was lowered by repetitive aqueous extraction, and an ash content of 5 ppm;

(10) PO(A): polyethylene (product of Japan Polychem Corporation, grade name: SF941) having a density of 0.936 g/cm³ (measured in compliance with JIS K6760) and an MFR of 2.0 g/10 min (measured in compliance with JIS K6760);

(11) PO(B): polypropylene (product of Mitsubishi Chemical Corporation, grade name: SPX8600LD) giving a melt peak at 136 ° C. (measured in compliance with JIS K7121), and having an MFR of 3.7 g/10 min (measured in compliance with JIS K6758);

(12) PO(C): a mixture of 85 wt % of polypropylene (product of Mitsubishi Chemical Corporation, grade name: SPX8600LD) giving a melt peak at 136° C. (JIS K7121) and having an MFR=3.7 g/10 min (JIS K6760), and 15 wt % of polyethylene (product of Japan Polychem Corporation, grade name: KF271) having a density of 0.913 g/cm³ (JIS K6760) and an MFR=2.0 g/10 min (JIS K6760);

(13) PO(D): a mixture of 60 wt % of polypropylene (product of Mitsubishi Chemical Corporation, grade name: SPX8600LD), giving a melt peak at 136° C. (JIS K7121) and having an MFR of 3.7 g/10 min (JIS K6758), and 40 wt % of polyethylene (product of Japan Polychem Corporation grade name: KF360) having density of 0.898 g/cm³ (JIS K6760) and an MFR of 3.5 g/10 min (JIS K6760);

(14) AD(E): an adhesive resin comprising a mixture of 45 wt % of modified polyethylene (product of Mitsubishi Chemical Corporation, grade name: M552) having density of 0.920 g/cm³ (JIS K6760) and an MFR=1.5 g/10 min (JIS K6760), and 55 wt % of polyethylene having a density of 0.898 g/cm³ (JIS K6760) and an MFR of 3.5 g/10 min (JIS K6760);

(15) AD(F): a modified polyethylene (product of Mitsubishi Chemical Corporation, grade name: F534) having a density of 0.900 g/cm³ (JIS K6760) and an MFR of 3.5 g/10 min (JIS K6760); and

(16) AD(G): an adhesive resin comprising a mixture of 60 wt % of modified polypropylene (product of Mitsubishi Chemical Corporation, grade name: P513V) having density of 0.900 g/cm³ (JIS K6760) and an MFR of 2.3 g/10 min (JIS K6758), and 40 wt % of polyethylene having a density of 0.898 g/cm³ (JIS K6760) and an MFR of 3.5 g/10 min (JIS K6760).

### EXAMPLES 1 To 6

<Method for Fabricating Multi-Layered Film>

A die for producing five-layered films was attached on the cylinder end of a water-cooled inflation molding machine. Using the die, tubular five-layered films individually having a constitution of outermost layer/mid-outer layer/intermediate layer/mid-inner layer/innermost layer in a thickness of 15 μm/77.5 μm/20 μm/77.5 μm/30 μm, folded diameter of 240 mm were produced at a die temperature of 235° C., an extrusion temperature of 245° C. for the outermost layer, 200° C. for the mid-outer layer, 240° C. for the intermediate layer, 200° C. for the mid-inner layer, and 200° C. for the innermost layer, at a take-up speed of 9 m/min, and an extrusion volume of 60 kg/h, where source polymers for the individual layers were listed in Table 1.

<Evaluation of Multi-layer film bag>

The bags were produced using the obtained multi-layered films, and evaluated according to the test methods listed below.

(a) Sealing property test at 121° C. The tubular (cylindrical) stacked (two-ply) film was cut into 210 mm×210 mm pieces, and the individual pieces were heat-sealed along three edges to thereby produce a plurality of bags. A plurality of bags are then packed with 700 ml of an 1% acetic acid aqueous solution or 700 ml of an 1% diethylamine aqueous solution, and the openings of the bags were closed by heat sealing. Thus obtained sample bags stacked in a five-decker form were placed in a high-temperature, high-pressure cooking and sterilization tester (product of Hirayama Manufacturing Corporation, Model PC-42R5E), pressurized, the atmospheric temperature was raised up to 121° C. and kept at this temperature for 30 minutes. The sample bags were then taken out from the tester, and evaluated according to the criteria below. That is, the sample bags found to be free from abnormality and to be suitable for sterilization were expressed by ∘, and those found to cause broken seal, wrinkle, lowered transparency or mutual adhesion and to be not suitable for use were expressed by ×.

(b) Odor barrier property: The sample bags after examined in the foregoing test (a) were taken out from the high-temperature, high-pressure cooking and sterilization tester and then subjected to a sensory test. In the sensory test, the sample bags for which acetic acid odor or amine odor are sensible were expressed by ×, and those not sensible were expressed by ∘.

(c) Evaporation residue test: Evaporation residue of the sample bags were measured according to the test method for plastic-made medical packaging materials in the Japanese Pharmacopoeia Thirteenth Edition. The bags same as those fabricated in the foregoing test (a) were filled with 700 ml of injection water (water), heated at 121° .C for 60 minutes to prepare specimens. Twenty milliliters of the test liquid was evaporated to dryness on a water bath, and the obtained residue was weighed after being dried at 105° C. for one hour. The standard requires the measurement value is suppressed to 1.0 mg or below, so that those showing the value of 1.0 mg or below were expressed by ∘, and those exceeding 1.0 mg were expressed by ×.

(d) Erasure test for felt-tip pen writing: Letters were written on the outermost layer of the five-layered film with an oil-base felt-tip pen (product of Zebra Co., Ltd., Hi-Mckee, Bold, Black), and are then gently wiped five minutes after with a piece of cotton immersed with disinfectant alcohol. The number of times of wiping repeated until the written letters completely become unreadable was counted. Those on which the letters are readable after 5 times of wiping were judged as giving good results in the erasure test for felt-tip pen writing.

(e) Haze (%): One of the sample bags after being subjected to the foregoing test (a) was measured for haze in compliance with JIS K7105, where a smaller value means a better transparency.

(f) Flexibility (kg/cm²): One of the sample bags after being subjected to the foregoing test (a) was measured for flexibility (stiffness) using a loop stiffness tester (product of Toyo Seiki Seisaku-sho, Ltd.), where a smaller value means a better flexibility.

(g) Heat sealing strength (kg/15 mm wide): The sample bags were heat sealed using a hot-plate-type sealing apparatus at a lower-plate sealing temperature of 100° C., an upper-plate sealing temperature of 180° C., and a sealing time of 7 seconds. The bags were then measured for strength of the heat-sealed portion in compliance with JIS Z1707 using a tensile tester (product of Orientec Corporation, model UCT-100), where a larger value means a better strength of the heat-sealed portion, which is more desirable.

(h) Curling property (cm): A test strips having a dimension of 15 mm×100 mm was cut out from the multi-layered film, set and fixed on a flat table so as to allow the edge thereof to stick out by 75 mm from the table edge, and the degree of curling from the table plane was measured using a JIS Class-1 scale. The smaller the value is, the smaller the curling of the multi-layered film end, which is more preferable.

(i) Anti-pinhole property: The multi-layered film was applied with 3,000 times of repetitive bending fatigue at 0° C. using Gelboflex tester (product of Rigaku Kogyo K.K.) in compliance with MIL-B-131, and the number of resultant pinholes on the multi-layered film was counted. In this test, count zero is the best.

(j) Bag fall strength: The bags after being examined by the foregoing test (a) were kept at 5° C. for 24 hours, and then fallen in parallel from a height of 2 m to observe occurrence of breakage. Those not caused the breakage after 5 repetitive times of the fall were expressed by ∘, and those resulted in the breakage were expressed by ×.

TABLE 1

| | | | Example 1 | Example 2 | Example 3 | Example 4 | Example 5 | Example 6 |
|---|---|---|---|---|---|---|---|---|
| Constitution | Outermost layer (15 μm) | | PEST(A) | PEST(C) | PEST(B) | PEST(A) | PEST(A) | PEST(A) |
| of | Mid-outer layer (77.5 μm) | | AD(F) | AD(F) | AD(F) | AD(F) | AD(F) | AD(F) |
| multi-layered | Intermediate layer (20 μm) | | PA(A) | PA(D) | PA(D) | PA(A) | PA(A) | PA(D) |
| film | Mid-inner layer (77.5 μm) | | AD(E) | AD(E) | AD(F) | AD(F) | AD(G) | AD(E) |
| | Innermost layer (30 μm) | | PO(A) | PO(A) | PO(C) | PO(C) | PO(D) | PO(B) |
| Various | Sealing property at 121° C. | | ◯ | ◯ | ◯ | ◯ | ◯ | ◯ |
| Properties | Odor barrier | Acetic acid odor | ◯ | ◯ | ◯ | ◯ | ◯ | ◯ |
| | property | Amine odor | ◯ | ◯ | ◯ | ◯ | ◯ | ◯ |

| | | | | | | |
|---|---|---|---|---|---|---|
| Evaporation residue test | ◯ | ◯ | ◯ | ◯ | ◯ | ◯ |
| Erasure test for felt-tip pen | ≧5 | ≧5 | ≧5 | ≧5 | ≧5 | ≧5 |
| writing (number of times) | | | | | | |
| Haze (%) | 15 | 17 | 15 | 14 | 13 | 11 |
| Flexibility (kg/cm²) | 0.70 | 0.60 | 0.62 | 0.67 | 0.70 | 0.75 |
| Heat-seal strength (kg/15 mm) | 5.4 | 5.5 | 5.0 | 5.1 | 4.6 | 5.0 |
| Curling property | 0.0 | 0.0 | 0.0 | 0.0 | 0.0 | 0.0 |
| Anti-pinhole property | 0 | 0 | 0 | 0 | 0 | 0 |
| Bag fall strength | ◯ | ◯ | ◯ | ◯ | ◯ | ◯ |

### Comparative Examples 1 to 5

<Method for Fabrication Multi-Layered Film>

The multi-layered films were fabricated according to the procedures similar to those in Example 1, except that the combinations of the source polymers are altered as being listed in Table 2.

<Evaluation of the Multi-layer film bag>

The obtained bags were subjected to the same 10 evaluation tests of (a) to (j) listed in the above similarly to Example 1. Results were shown in Table 2.

The bag in Comparative Example 4 showed deformation (scare) after the sealing property test at 121° C., which is possibly ascribable to dimensional changes, and have an extremely degraded appearance. The bag in Comparative Example 5 was also found to be suffering from degraded appearance, partially showing an approx. 2-cm-wide portion in which fine scaly patterns are repeated.

TABLE 2

| | | | Comparative | Comparative | Comparative | Comparative | Comparative |
|---|---|---|---|---|---|---|---|
| | | | example 1 | example 2 | example 3 | example 4 | example 5 |
| Constitution | Outermost layer (15 μm) | | PEST(A) | PO(B) | PO(A) | PEST(D) | PEST(A) |
| of | Mid-outer layer (77.5 μm) | | AD(F) | AD(F) | AD(F) | AD(F) | AD(F) |
| multi-layered | Intermediate layer (20 μm) | | PA(B) | PA(C) | PA(B) | PA(A) | PA(E) |
| film | Mid-inner layer (77.5 μm) | | AD(E) | AD(E) | AD(E) | AD(E) | AD(E) |
| | Innermost layer (30 μm) | | PO(A) | PO(A) | PO(A) | PO(A) | PO(A) |
| Various | Sealing property at 121° C. | | ◯ | X | X | ◯ | ◯ |
| Properties | Odor barrier | Acetic acid odor | ◯ | X | X | ◯ | ◯ |
| | property | Amine odor | ◯ | X | X | ◯ | ◯ |

| | | | | | |
|---|---|---|---|---|---|
| Evaporation residue test | X | X | X | ◯ | ◯ |
| Erasure test for felt-tip pen | ≧5 | 1 | 3 | ≧5 | ≧5 |
| writing (number of times) | | | | | |
| Haze (%) | 18 | 16 | 19 | ≧20 | ≧20 |
| Flexibility (kg/cm²) | 0.59 | 0.60 | 0.62 | 1.5 | 1.7 |
| Heat-seal strength (kg/15 mm) | 5.4 | 5.5 | 5.1 | 5.4 | 5.0 |
| Curling property | 0.0 | 0.2 | 1.8 | 0.0 | 0.0 |
| Anti-pinhole property | 0 | 1 | 2 | 3 | 2 |
| Bag fall strength | ◯ | ◯ | ◯ | X^{*1} | X^{*2} |

^{*1}Ruptured form the sealed edge.
^{*2}Ruptured around the bag center.

Tables 1 and 2 revealed the following facts.

The multi-layer film bag for packaging medical liquid according to the present invention has on the outermost thereof a polyester layer composed of a specific polybutylene terephthalate, so that the bag is excellent in odor barrier property, heat resistance, flexibility, heat-seal strength and affinity with ink for printing or felt-tip pen, on which the letters written with such ink is not easily erasable (Examples 1 to 6).

The multi-layer film bag for packaging medical liquid according to the present invention has a specific polyamide layer as one constituent, so that the bag can pass the test for plastic-made medical packaging materials and elution test specified in the Japanese Pharmacopoeia Thirteenth Edition and is thus excellent in hygienic property, produces less evaporation residue, and causes less elution into medical liquid when used for medical purposes (Examples 1 to 6).

On the contrary, the bag having on the outermost thereof a polyethylene layer was found to be poor in heat-seal property (Comparative Examples 2 and 3).

Even when a layer composed of a polyester other than the polybutylene terephthalate specified by the present invention is the outermost layer, only poor transparency, flexibility and anti-pinhole property are attainable, and the bag fall strength is limitative so as to cause breakage from the sealed edge (see Comparative Example 4). Another problem is found that even when the outermost layer is composed of such specified polybutylene terephthalate, the multi-layer film bag for packaging medical liquid will produce a lot of evaporation residue and eluted components into the content if the intermediate layer is composed of a polyamide having a ratio of content of low-molecular-weight polymer exceeding 0.7 wt % (see Comparative Example 1).

It was also found that the multi-layered film having a single polyamide layer comprising polyamide (Comparative Example 5), a relative viscosity of which (=2.0) being lower than the specified range, caused uneven flow statuses of different layers during the film formation, which significantly degraded appearance and also resulted in poor breakage strength and bag fall strength.

As has been described in the above, the present invention has special advantages described in the next, and the industrial applicability thereof is extremely large.

1. Since the multi-layer film bag for packaging medical liquid of the present invention comprises the multi layered film which comprises at least five specifically-defined layers, so that the bag is excellent in the flexibility, heat seal strength and mechanical strength as compared with those of the conventional liquid bag having a polyolefin layer on the outermost thereof, and hardly breaks if fallen;

2. The multi-layer film bag for packaging medical liquid of the present invention has on the outermost thereof a specific polyester layer, so that the surface of the bag has an improved affinity with ink without being processed by corona discharge treatment unlike the conventional liquid bag having a polyolefin layer on the outermost thereof. This simplifies the fabrication process of such multi-layered film, allows the liquid bag to directly be printed or written with product's name or description thereof, and improves the abrasion resistance of the printed surface so as not to be readily erasable due to friction or abrasion during the transportation or the like;

3. The multi-layer film bag for packaging medical liquid of the present invention has on the outermost thereof a specific polyester layer, so that the bag is excellent in heat resistance, and can be subjected to heat sterilization in a stacked manner in a large batch unlike the conventional liquid bag having a polyolefin layer on the outermost thereof;

4. The multi-layer film bag for packaging medical liquid of the present invention has an excellent gas barrier property, so that liquid contained therein is effectively prevented from being denatured, and the bag is not likely to cause expansion in the capacity thereof;

5. The multi-layer film bag for packaging medical liquid of the present invention comprises at least five layers including the specific polyester layer and the specific polyamide layer, so that the bag has an improved gas barrier property as compared with that of the conventional liquid bag having a polyolefin layer on the outermost thereof, and will not leak odor of the content even when a strongly odorous liquid is contained, which successfully avoids discomfort in the storage or handling;

6. The multi-layer film bag for packaging medical liquid of the present invention includes a specific polyamide layer, so that the bag will not cause elution of the low-molecular-weight components even when processed under heating, to thereby prevent pollution of the content;

7. The multi-layer film bag for packaging medical liquid of the present invention uses a specific polyamide layer as the intermediate layer, so that the bag is excellent in extrusion moldability, which ensures stable production of the bag for packaging medical liquid with a desirable strength and appearance;

8. The multi-layer film bag for packaging medical liquid of the present invention is excellent in flexibility, and allows compact disposal while being reduced in the volume after use; and

9. The multi-layer film bag for packaging medical liquid of the present invention will not emit any hazardous substances when combusted after disposal.

What is claimed is:

1. A multi-layer film bag for packaging medical liquid, wherein
the multi-layered film comprises at least five layers in which a polyester layer is located on the outermost, and an adhesive layer, a polyamide layer, an adhesive layer and an polyolefin layer are stacked in this order towards the innermost;
said polyester layer comprising polybutylene terephthalate which contains terephthalic acid as a major dicarboxylic acid component and butylene glycol as a major diol component;
said polybutylene terephthalate having an intrinsic viscosity of 0.6 to 2.0 and the content of carboxylic terminal of 3 to 60 μeq/g; and
said polyamide layer comprising polyamide 6, polyamide 6-66 or a mixture thereof, and having a relative viscosity of 2.1 to 6.0, a ratio of content of low-molecular-weight polymers of 0.7 wt % or below, and an ash content of 500 ppm or below.

2. The multi-layer film bag for packaging medical liquid as claimed in claim 1, wherein the total thickness of said multi-layered film is 0.08 to 0.6 mm, the thickness of said polyolefin layer and said adhesive layers are 0.003 to 0.2 mm, the thickness of said polyester layer is 0.005 to 0.2 mm, and the thickness of said polyamide layer is 0.003 to 0.06 mm.

3. The multi-layer film bag for packaging medical liquid as claimed in claim 1, wherein said polybutylene terephthalate is a polymer or a copolymer in which the dicarboxylic acid component thereof comprises terephthalic acid, and the diol components thereof comprises 70 to 100 wt % of butylene glycol and 30 to 0 wt % of polybutylene glycol having a weight average molecular weight of 400 to 3000.

4. The multi-layer film bag for packaging medical liquid as claimed in claim 1, wherein said polybutylene terephthalate has an intrinsic viscosity of 0.9 to 1.5.

5. The multi-layer film bag for packaging medical liquid as claimed in claim 1, wherein said polybutylene terephthalate has a content of carboxylic end group of 3 to 40 μeq/g.

6. The multi-layer film bag for packaging medical liquid as claimed in claim 1, wherein said polyamide 6, polyamide 6-66 or mixture thereof has a ratio of content of low-molecular-weight polymer of 0.5 wt % or below.

7. The multi-layer film bag for packaging medical liquid as claimed in claim 1, wherein said polyamide 6 or polyamide 6-66 has an ash content of 300 ppm or below.

8. The multi-layer film bag for packaging medical liquid as claimed in claim 1, wherein said polyamide 6 or polyamide 6-66 has an ash content of 100 ppm or below.

9. The multi-layer film bag for packaging medical liquid as claimed in claim 11, wherein said polyolefin layer comprises any one component selected from the group consisting of polyethylene, polypropylene, and mixture of ethylene-propylene copolymer and polyethylene.

10. The multi-layer film bag for packaging medical liquid as claimed in claim 1, wherein said polyolefin layer comprises a polymer which has an MFR of 0.1 to 30 g/min and is mainly composed of ethylene.

11. The multi-layer film bag for packaging medical liquid as claimed in claim 1, wherein said polyolefin layer comprises a polymer which has an MFR of 0.1 to 100 g/min and is mainly composed of propylene or styrene.

12. The multi-layer film bag for packaging medical liquid as claimed in claim 1, wherein said adhesive layer mainly comprises a modified polyolefin.

13. The multi-layer film bag for packaging medical liquid as claimed in claim 11, wherein said modified polyolefin is a polymer mainly composed of ethylene, and has an MFR of 0.1 to 30 g/min.

14. The multi-layer film bag for packaging medical liquid as claimed in claim 11, wherein said modified polyolefin is a polymer mainly composed of propylene or styrene, and has an MFR of 0.1 to 100 g/min.

15. The multi-layer film bag for packaging medical liquid as claimed in claim 1, wherein said multi-layered film is produced by the water-cooled inflation molding process.

16. The multi-layer film bag for packaging medical liquid as claimed in claim 1, wherein said multi-layered film is produced in a cylindrical form by the water-cooled inflation molding process and then heat-sealed at least partially.

17. The multi-layer film bag for packaging medical liquid as claimed in claim 1 used for packaging at least one medical liquid selected from infusion liquid, liquid for artificial kidney dialysis, liquid for peritoneal dialysis, blood, humor and liquid medicines.
